(19) United States
(12) Patent Application Publication
(10) Pub. No.: US 2023/0205517 A1
(43) Pub. Date: Jun. 29, 2023

(54) AUTOMATED USE OF COMPUTATIONAL MOTIFS VIA DEEP LEARNING DETECTION

(71) Applicant: Advanced Micro Devices, Inc., Santa Clara, CA (US)

(72) Inventors: Jakub Kurzak, Santa Clara, CA (US); Nicholas Penha Malaya, Austin, TX (US)

(21) Appl. No.: 17/562,921

(22) Filed: Dec. 27, 2021

(51) Int. Cl. G06F 8/71; G06F 8/41; G06F 9/455

(52) U.S. Cl. CPC G06F 8/71; G06F 8/4434; G06F 8/4432; G06F 9/45516

(57) ABSTRACT

A system and method are described for efficiently utilizing optimized implementations of computational patterns in an application. In various implementations, a computing system includes at least one or more processors, and these one or more processors and other hardware resources of the computing system process a variety of applications. Sampled, dynamic values of hardware performance counters are sent to a trained data model. The data model provides characterization of the computational patterns being used and the types of workloads being processed. The data model also indicates whether the identified computational patterns already use an optimized version. Later, a selected processor determines a given unoptimized computational pattern is no longer running and replaces this computational pattern with an optimized version. Although the application is still running, the processor performs a static replacement. On a next iteration of the computational pattern, the optimized version is run.

### BACKGROUND

### Description of the Relevant Art

The combination of advances in software techniques, the higher integration of numerous and various functions on a single integrated chip substrate, and faster network data transfers has greatly increased the performance of computing systems. The higher throughput being achieved occurs for applications in several fields such as the business and financial fields, the higher learning field, the medical field, the entertainment field, and so on. However, the interrelationships between on-die components become more complex as well as the interrelationships between software components. Combine these complexities with a shortening time-to-market, and unfortunately, software developers many times fail to identify opportunities for leveraging existing solutions. An example of these existing solutions are numerous software packages offer highly optimized implementations of common computational patterns that go unused.

Usually, the above issues are difficult to avoid without expert-level multidisciplinary knowledge. Reducing the missed opportunities of leveraging the advances in both software and hardware techniques occurs through traditional performance analysis and engineering techniques based on human intervention. Such a method is tedious, labor-intensive, and costly in commercial settings.

In view of the above, methods and systems for efficiently utilizing optimized implementations of computational patterns in an application are desired.

### BRIEF DESCRIPTION OF THE DRAWINGS

FIG. 1 is a generalized diagram of control flow graphs and elements of a computing system.

FIG. 2 is a generalized diagram of control flow graphs and elements of a computing system.

FIG. 3 is a generalized diagram of program characterization.

FIG. 4 is a generalized diagram of a method for efficiently utilizing optimized implementations of computational patterns in an application.

FIG. 5 is a generalized diagram of a method for efficiently utilizing optimized implementations of computational patterns in an application.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Systems and methods for efficiently utilizing optimized implementations of computational patterns in an application are contemplated. In various implementations, a computing system includes at least one or more processors and a memory that stores an optimizer, a data model, and at least one application. In some implementations, the one or more processors are included in an integrated circuit. Examples of the integrated circuit are a central processing unit (CPU), a graphics processing unit (GPU), an accelerated processing unit (APU) that includes both a CPU and a GPU, one of a variety of types of an application specific integrated circuit (ASIC), a system on a chip (SoC), and so forth.

In an implementation, the data model is one of a variety of types of deep learning models (e.g., neural network based or otherwise). During prior training of the data model, the one or more processors and other hardware resources of the computing system process a variety of applications. The values stored in hardware performance counters across the computing system, the corresponding thresholds, and user knowledge of the dynamic behavior of the applications are used to train the data model. The data model is trained to identify types of workloads of executing applications. The trained data model also identifies the corresponding types of computational patterns. For example, during training of the data model known types of applications and workloads are run on target hardware. During execution, hardware counters capture data indicative of various hardware events. Examples of such events include floating-point arithmetic operations, memory store (write) operations, memory load (read) operations, cache misses at a particular level of the cache memory subsystem, integer arithmetic operations, threshold levels of memory bandwidth consumption, utilization levels of particular buffers, and so on. These events are then correlated with operations currently being performed by the hardware (e.g., program code was written to perform convolution operations). By correlating the captured patterns of events with known computational activities, the data model is trained so that it can identify such patterns to a desired level of certainty. Additionally, combinations of patterns may be identified as a larger pattern (e.g., a sequence of patterns including a convolution operation followed by a pooling operation may be identified). Other patterns may indicate a particular type of workload, such as face recognition tasks/operations, voice recognition, or otherwise. These and other embodiments are possible and are contemplated here.

After training, as the one or more processors and other hardware resources of the computing system process a variety of applications, the hardware performance counters are sampled. The sampled, dynamic values of the hardware performance counters are sent to the trained data model. With these values as input, the trained data model provides characterization of the computational patterns being used and the types of workloads being processed. In one example, the trained data model recognizes a face recognition workload and identifies a corresponding matrix multiplication operation. In addition, the trained data model provides an indication of whether the identified computational patterns already use an optimized version of the corresponding operation (or algorithm), or they use an unoptimized version. When a computational pattern has two or more versions, each version includes program code performing the operation of the computational pattern. In one example, a computational pattern corresponding to a matrix multiplication has two versions. Each version includes program code that performs the matrix multiplication operation. However, determining a particular version is more optimized than another version is based on criteria that includes one or more of performance, power consumption, and utilized data storage. Therefore, the different versions satisfy different tradeoffs. For example, the user determines the criteria indicates one of higher performance (higher throughput), lower power consumption, and lower data storage utilization (or lower memory bandwidth).

The circuitry of a selected processor of the computing system executes an optimizer, and accordingly, receives the output characterization information from the trained data model. When executing the optimizer, the selected processor identifies which identified computational patterns are unoptimized based on the criteria and determines whether optimized versions of these computational patterns are available. For example, it is possible that a runtime library includes the different versions of the computational pattern. In an implementation, a user selects the criteria and provides an indication of the criteria to the optimizer through a graphical user interface (GUI), a command line prompt, a text file to be accessed, or other. At a later point in time, the processor determines program code associated with an identified computational pattern is no longer running and replaces this computational pattern with an optimized version. Since the program code associated with computational pattern is not running, the code may be replaced without the need to save and restore an associated context In other implementations, an identification of computation patterns is detected and stored and program code associated with the identified patterns is replaced after execution of the application completes execution. In either case, an indication that alternative program code (e.g., optimized or otherwise alternative version) are to be used in further executions of the application.

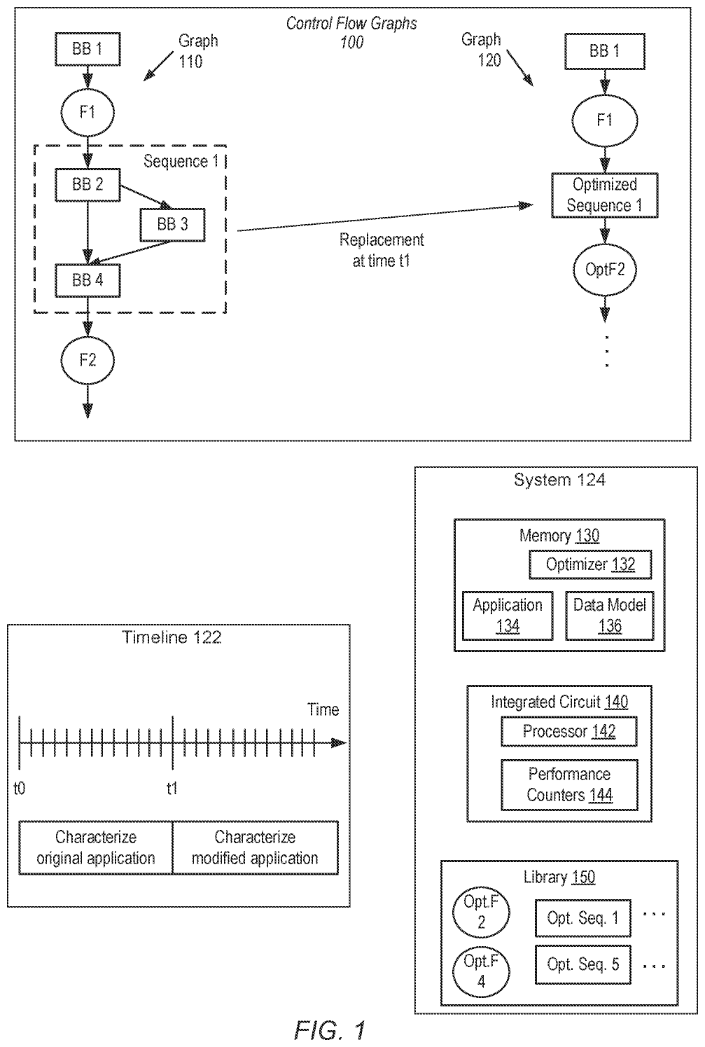

Turning now to FIG. 1, a generalized diagram is shown of control flow graphs 100, a timeline 122, and a system 124. The control flow graphs 100 include control flow graph 110 (or graph 110) and graph 120. Graphs 110 and 120 represent paths that can be traversed through an application or a portion of the application during its execution. Shown in the bottom right corner are memory 130 and integrated circuit 140. The graph 110 represents paths that can be traversed in a portion of the source code and resulting compiled byte code of application 134 stored in memory 130 when executed by the processor 142 in the integrated circuit 140. The graph 120 represents an optimized version of graph 110. Shown in the bottom left corner is a timeline 122. From the point in time t0 (or time t0) to time t1, the graph 110 is used to represent a portion of application 134 when unoptimized code is used. From the point in time t1 and on, the graph 120 is used to represent the same portion of application 134 when optimized code is used. For example, at least the library 150 includes optimized operations that are linked to application 134. In an implementation, the library 150 is a runtime library. Although shown externally, in various implementations, the library 150 is stored in one of a variety of storage devices used to implement memory 130. In addition to the above, embodiments are contemplated that include runtime compilation (e.g., just in time compilation) to recompile program code to include optimized version of program code. All such embodiments are possible and are contemplated herein.

The graph 110 is an original (and unoptimized) control flow graph of a portion of the application 134, and the graph 120 is an optimized version of the graph 110. Typically, in a control flow graph, each node in the graph represents a basic block. Here, though, function calls are also shown. For example, the blocks labeled with “BB” and a number represent basic blocks, and the ellipses labeled with “F” and a number represent function calls. Most representations include an entry block, through which control enters the control flow graph, and an exit block, through which control leaves the control flow graph.

In an implementation, at least a portion of the application 134 provides the graph 110 with four basic blocks numbered from basic block 1 (BB 1) to basic block 4 (BB 4). Each one of the basic blocks BB 1 to BB 4 is a sequence of instructions with one entry point and one exit point. The graph 110 also includes two function calls numbered from function call 1 (F1) to function call 2 (F2). Each of the function calls uses one or more basic blocks, which could have been shown instead. However, for ease of illustration, this amount of detail of the function calls is not shown. In addition, different versions of a function call that provide the same functionality use a different number, size and arrangement of basic blocks, which is further described shortly. Although four basic blocks and two function calls are shown, in other examples, another number of basic blocks and function calls are used. For the unoptimized graph 110, basic block BB 1 is the entry block and function call F2 is the exit. Similarly, the optimized graph 120 uses basic block BB 1 as the entry block and function call F2 as the exit.

The library 150 includes the code of optimized operations such as computational patterns, which are also referred to as computational motifs. These computational patterns are segments of code, such as a subprogram, that provide a particular functionality that can be placed in one or more locations in various applications. Examples of these computational patterns are: a sort operation, a dense matrix operation, a sparse matrix operation, a fast Fourier transform (FFT) operation, and so on. The granularity of the code segments used to implement a computational pattern varies. In one example, the granularity is at the level of a function call or a subroutine call. As shown, the graph 110 uses the function call F2, and the library 150 includes an optimized version of this function call labeled as “Opt. F2.” In another example, the granularity of the code segments is at the level of one or more basic blocks. As shown, the graph 110 uses the combination of basic blocks BB 2 to BB 4 in the Sequence 1, and the library 150 includes an optimized version of this sequence labeled as “Opt. Seq. 1.” The graph 110 represents an IF-THEN-ELSE construct with basic blocks BB2 to BB 4.

Another example of the code segments used to implement a computational pattern is at the level of a series of instructions within a basic block. Yet another example of the granularity is at a level larger than a function call. This granularity includes a combination of one or more function calls. This granularity can also include one or more function calls and one or more series of instructions or basic blocks. Therefore, the granularity of the code segments used to implement a computational pattern includes a range from a series of instructions to higher-level constructs. In addition to functions and/or subroutines defined in the library 150, the code segments used to implement a computational pattern also include functions that are built into the compiler. These types of functions are referred to as intrinsic functions or compiler intrinsics.

The data model 136 is used to identify the code segments of application 134 used to implement a computational pattern. When the circuitry of the processor 142 executes a copy of the data model 136 in an implementation, the processor 142 performs the functionality of a deep learning model. For example, the data model 136 is one of a variety of types of deep learning models. In an implementation, the data model 136 is the GPT (Generative Pre-Training) model provided by Open AI. In another implementation, the data model 136 is the BERT (Bidirectional Encoder Representations from Transformers) model. Other types of models are also possible and contemplated. During prior training of the data model 136, one or more processors—such as the processor 142 and other hardware resources of a computing system that uses the integrated circuit 140—process a variety of applications. During this processing, a variety of hardware events occur and an identification of these events is used to train the data model.

Examples of the hardware events are floating-point arithmetic operations, memory store (write) operations, memory load (read) operations, cache misses at a particular level of the cache memory subsystem, integer arithmetic operations, and so on. The hardware performance counters 144 are registers distributed across the integrated circuit 140 that collect statistics used to describe the dynamic behavior of the applications being run. For example, the statistics identify the hardware events that occur during the execution of the applications.

A combination of the dynamic values stored in the hardware performance counters 144 over time, the corresponding thresholds, and upfront user knowledge of the dynamic behavior of the applications are used to train the data model 136. The trained data model 136 becomes capable of identifying types of workloads of executing applications. The trained data model 136 also identifies the corresponding types of computational patterns. Examples of the types of workloads are face recognition workloads, social media workloads, digital signal processing workloads, convolutional neural network workloads, graph processing workloads, and so on. Examples of the computational patterns are: a sort operation, a dense matrix operation, sparse matrix operation, a fast Fourier transform (FFT) operation, and so on. Further, in an implementation, both optimized versions and unoptimized versions of computational patterns are used during training so that the data model 136 is able to distinguish between the two versions.

After training, as the hardware resources of the integrated circuit 140 process a variety of applications, such as the application 34, the hardware performance counters 144 are sampled. For example, multiple hash marks are shown between time t0 and time t1 on the timeline. In an implementation, these hash marks indicate a particular time interval has elapsed, which causes another sampling of the hardware performance counters 144. The sampled, dynamic values of the hardware performance counters 144 are sent to the trained data model 136. With these values as input, the trained data model 136 provides characterization of the computational patterns being used and the types of workloads being processed. In addition, the trained data model 136 provides an indication of whether the identified computational patterns already use an optimized version of the corresponding operation (or algorithm), or they use an unoptimized version.

When the circuitry of the processor 142 executes a copy of the optimizer 132, in an implementation, the processor 142 receives the output characterization information from the trained data model 136 and analyzes it. When executing the optimizer 132, the processor 142 determines which identified computational patterns are unoptimized, and also determines whether optimized versions of these computational patterns are available. For example, it is possible that the library 150 or other source includes the optimized versions. When a computational pattern has two or more versions, each version includes program code performing the operation of the computational pattern. In one example, a computational pattern corresponding to a matrix multiplication has two versions. Each version includes program code that performs the matrix multiplication operation. However, determining a particular version is more optimized than another version is based on criteria that includes one or more of performance, power consumption, and utilized data storage. Therefore, the different versions satisfy different tradeoffs. For example, the user determines the criteria indicates one of higher performance (higher throughput), lower power consumption, and lower data storage utilization (or lower memory bandwidth).

When executing the optimizer 132, the processor 142 identifies which identified computational patterns are unoptimized based on the criteria and determines whether optimized versions of these computational patterns are available. For example, it is possible that the library 150 includes the different versions of the computational pattern. In an implementation, a user selects the criteria and provides an indication of the criteria to the optimizer 132 through a graphical user interface (GUI), a command line prompt, a text file to be accessed, or other. At a later point in time, the processor 142 determines program code associated with an identified computational pattern is no longer running and replaces this program code with a version that has been optimized to perform operations associated with the computational pattern.

As shown at time t1 on the timeline, the processor 142 performs a replacement of the Sequence 1 with the optimized version labeled as “Opt. Seq. 1.” Additionally, the processor 142 performs a replacement of the function call F2 with the optimized version labeled as “Opt. F2.” Therefore, after time t1 during a next iteration of these computational patterns of Sequence 1 and function call F2, the optimized versions are run. The resulting optimized control flow graph is shown as graph 120. After time t1, the sampling of the hardware performance counters 144 continues, and a further replacement of computational patterns occurs again further down the timeline.

In an implementation, a reset of the hardware performance counters 144 occurs at time t1. In another implementation, the reset occurs when a time interval different than the sampling time interval elapses. In some implementations, the time t1 indicates a particular time interval greater than the sampling interval has elapsed. In another implementation, the time t1 indicates the processor 142, while executing the optimizer 132, has determined a threshold number of computational patterns have been identified. A variety of other conditions used for defining the time t1 are possible and contemplated.

As shown, the memory 130 is capable of storing the data model 136 and one or more applications such as the optimizer 132 and application 134. Although not shown for ease of illustration, the memory 130 is also capable of storing an operating system, source data for the applications, intermediate result data and final result data generated by at least the processor 142 when executing a particular application, dynamic data provided by the hardware performance counters 144 over time, and so on. In some implementations, the memory 130 includes one or more of a hard disk drive, a solid-state disk, other types of flash memory, a portable solid-state drive, one of a variety of types of dynamic random access memory (DRAM), a tape drive, and so on.

Although the integrated circuit 140 is shown to include a single processor 142, in various implementations, the integrated circuit 140 includes any number of processors, each with one or more processor cores or one or more compute units. Examples of the integrated circuit 140 are a central processing unit (CPU), a graphics processing unit (GPU), an accelerated processing unit (APU) that includes both a CPU and a GPU, one of a variety of types of an application specific integrated circuit (ASIC), a system on a chip (SoC), and so forth.

The integrated circuit 140 also includes other components to provide particular functionality. These components are not shown for ease of illustration. Examples of these components are a power manager, a communication fabric and/or system buses, a memory controller, a network interface unit, an input/output interface unit for communicating with external peripheral devices, one or more phased locked loops (PLLs) and other clock generation circuitry, temperature sensors and current sensors, and so forth. As described earlier, the hardware performance counters 144 are distributed across the integrated circuit 140.

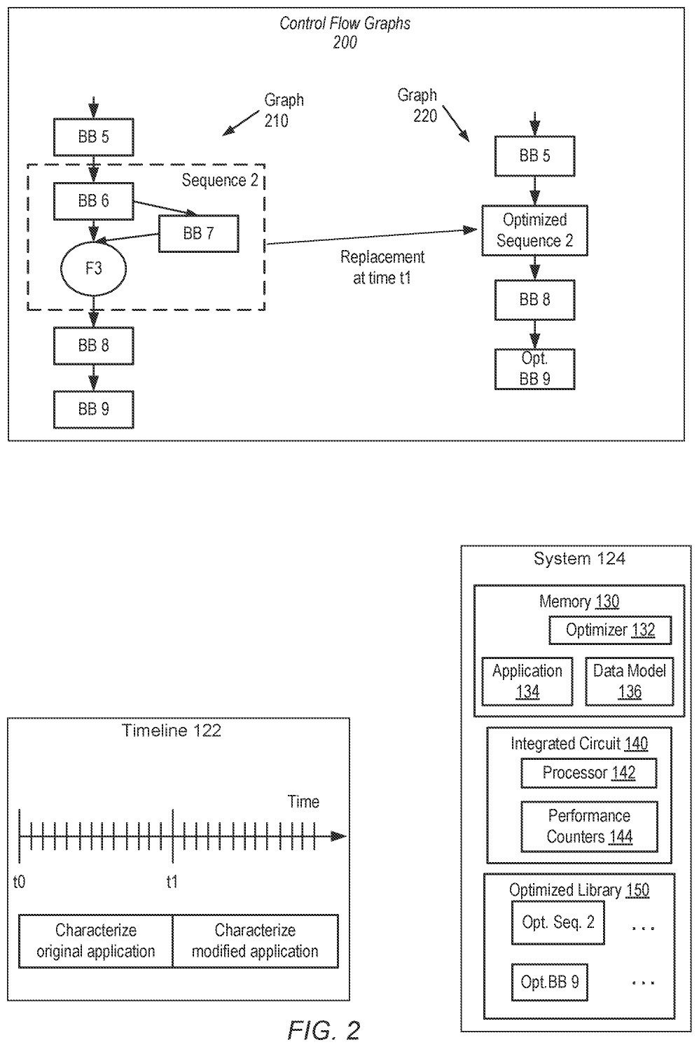

Referring to FIG. 2, a generalized diagram is shown of control flow graphs 200. Circuitry, processing elements, and logic described earlier are numbered identically. The control flow graphs 200 include control flow graph 210 (or graph 210) and graph 220. Graphs 210 and 220 represent further paths that can be traversed through a portion of the application 134 being executed by the processor142. At least a portion of the application 134 provides the graph 210 with five basic blocks numbered from basic block 5 (BB 5) to basic block 9 (BB 9). The graph 210 also includes Sequence 2 that corresponds to a particular computational pattern. The Sequence 2 includes two basic blocks BB 6 and BB 7 as well as the function call F3. The Sequence 2 uses the IF-THEN-ELSE construct. The library 150 includes an optimized version of this sequence labeled as “Opt. Seq. 2.” The library 150 also includes an optimized version of the basic block B9, which is labeled as “Opt. BB 9.”

As shown at time t1 on the timeline, when executing the optimizer 132, the processor 142 performs a replacement of the Sequence 2 with the optimized version labeled as “Opt. Seq. 2.” Additionally, the processor 142 performs a replacement of the basic block B9 with the optimized version labeled as “Opt. BB 9.” Therefore, after time t1 during a next iteration of these computational patterns of Sequence 2 and basic block B9, the optimized versions are run. The resulting optimized control flow graph is shown as graph 220. After time t1, the sampling of the hardware performance counters 144 continues, and a further replacement of computational patterns occurs again further down the timeline.

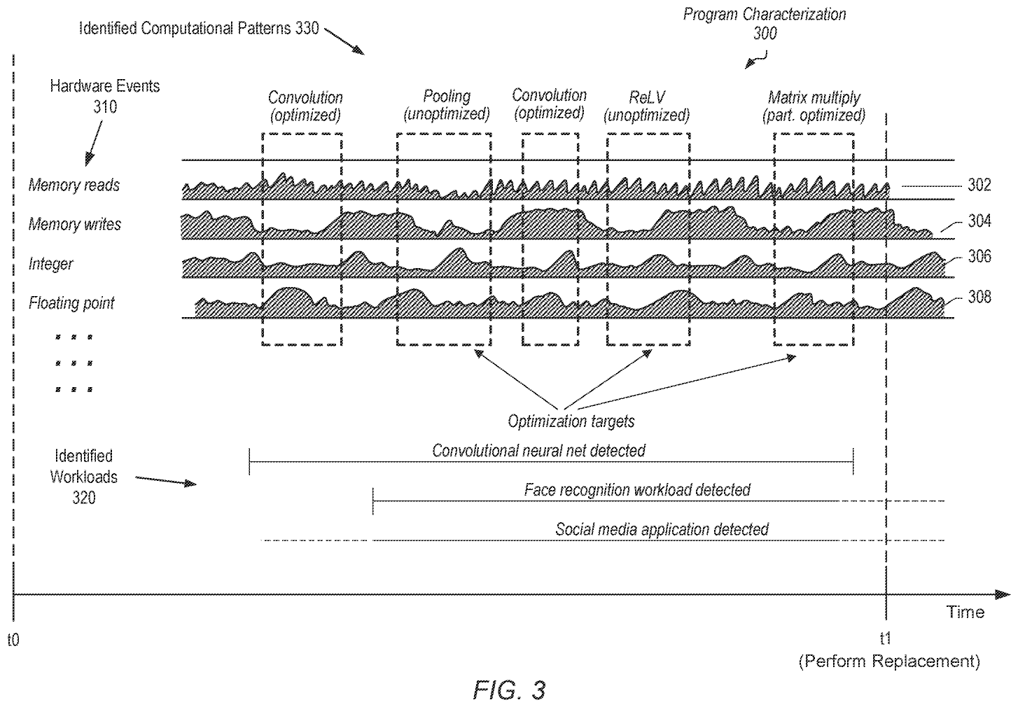

Turning now to FIG. 3, a generalized diagram is shown of program characterization 300. As shown, the dynamic values 302-308 of multiple types of monitored hardware events 310 are used to identify both workloads 320 and computational patterns 330. For example, a particular combination of a number of memory reads, memory writes, integer operations, events within a period of time, or other events, and so on, may be identified as corresponding to a convolution operation. As described earlier, hardware performance counters distributed across an integrated circuit are sampled, which provides the dynamic values 302-308. A trained data model uses the dynamic values 302-308 to identify both workloads 320 and computational patterns 330. In the example shown, patterns corresponding to convolution, pooling, ReLV (reticular linear unit/activation function), and matrix multiply are depicted. Numerous other types of patters are possible and are contemplated. As described earlier, the data model is one of a variety of types of deep learning models. The sampling of the hardware performance counters occurs at least from time t0 to time t1 on the timeline.

At time t1 on the timeline, a processor performs a replacement of one or more of the identified computational patterns 330. For example, three “optimization targets” are identified for replacement. In an implementation, the processor determines multiple conditions are satisfied before performing the replacement. For example, one condition is the computational pattern is currently using an unoptimized (or program code with an unknown optimization states) version of code used to provide the corresponding functionality. A second condition is an optimized or alternative version of the code is found in a library or other location. A third condition is program code associate with the identified computational pattern is currently not running at time t1. Since the program code associate with the identified computational pattern is not running, replacing the existing code with new code may be achieved without the need to save and restore a context (e.g., current state, etc.) associated with the code. Assuming the application is still running, the program code is replaced and if the portion of code in question is executed again the new code (e.g., an optimized version) is run.

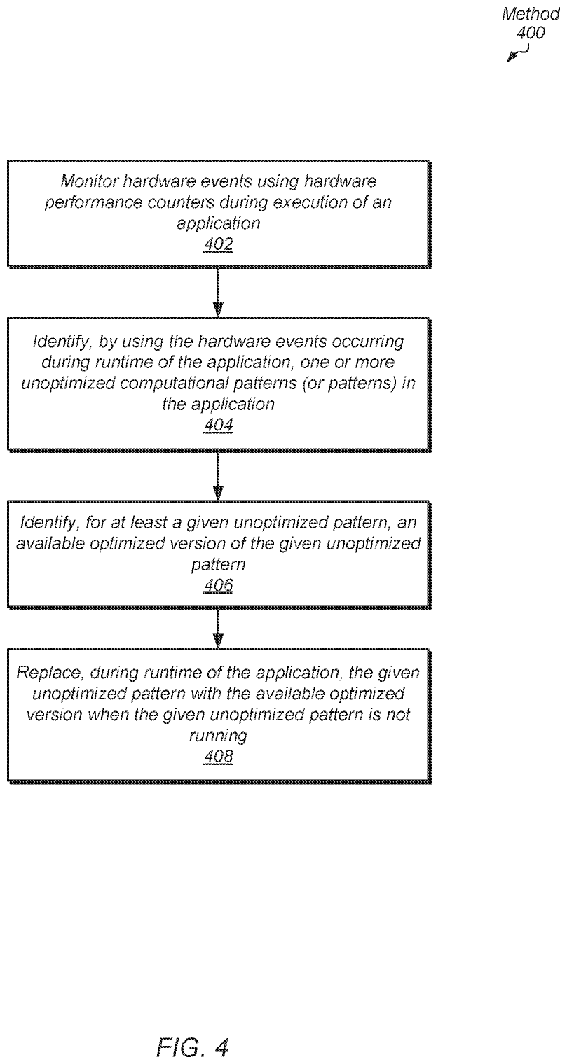

Referring to FIG. 4, a generalized diagram is shown of a method 400 for utilizing optimized implementations of computational patterns in an application. For purposes of discussion, the steps in this embodiment are shown in sequential order. However, in other embodiments some steps occur in a different order than shown, some steps are performed concurrently, some steps are combined with other steps, and some steps are absent.

A processor monitors hardware events in a computing system using hardware performance counters during execution of an application (block 402). The processor executes a trained data model such as one of a variety of types of deep learning models. When executing the data model, the processor identifies, by using the hardware events occurring during runtime of the application, one or more unoptimized computational patterns (or patterns) in the application (block 404). As described earlier, when a computational pattern has two or more versions, each version includes program code performing the operation of the computational pattern. In one example, a computational pattern corresponding to a matrix multiplication has two versions. Each version includes program code that performs the matrix multiplication operation. However, determining a particular version is more optimized than another version is based on criteria that includes one or more of performance, power consumption, and utilized data storage. Therefore, the different versions satisfy different tradeoffs. For example, the user determines the criteria indicates one of higher performance (higher throughput), lower power consumption, and lower data storage utilization (or lower memory bandwidth). In an implementation, a user selects the criteria and provides an indication of the criteria to the optimizer through a graphical user interface (GUI), a command line prompt, a text file to be accessed, or other.

The processor identifies, for at least a given unoptimized pattern, an available optimized version of the given unoptimized pattern (block 406). For example, the optimized version is located in an available library or other available location. The processor replaces, during runtime of the application, program code associated with the given identified computational pattern with the available optimized version when the given unoptimized pattern is not running (block 408). Another condition for replacement includes a particular time interval greater than the sampling interval has elapsed. In another implementation, another condition for replacement includes determining a threshold number of computational patterns have been identified. A variety of other conditions used for defining when to perform replacement are possible and contemplated.

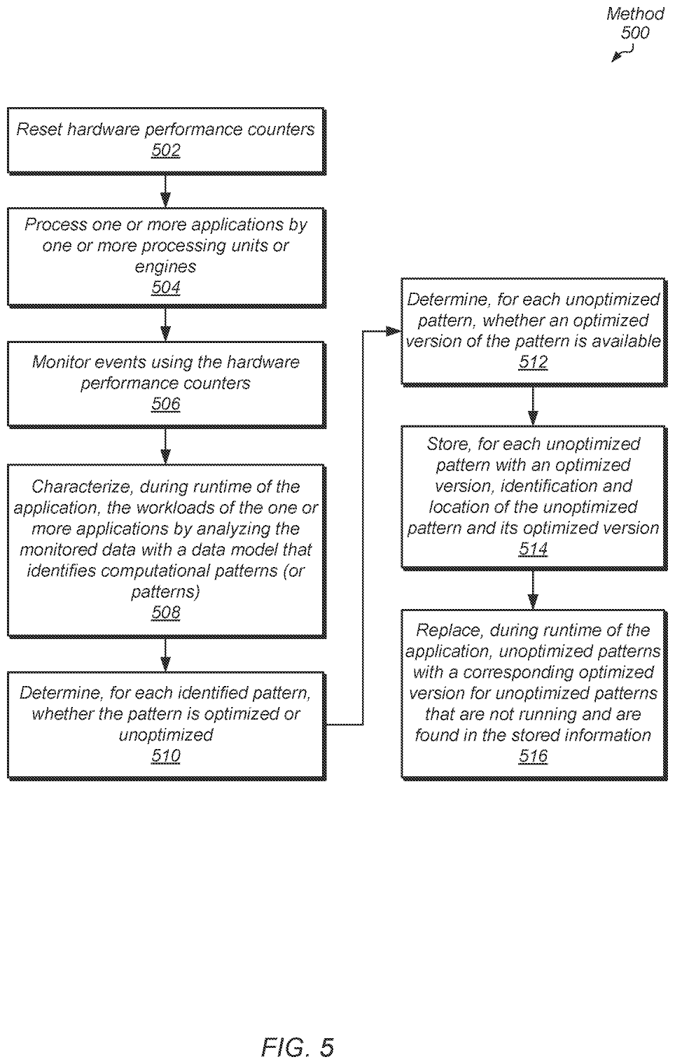

Turning now to FIG. 5, a generalized diagram is shown of a method 500 for utilizing optimized implementations of computational patterns in an application. A processor or circuitry of distributed control logic resets hardware performance counters (block 502). One or more processors and compute engines process one or more applications (block 504). The hardware performance counters monitor hardware events (block 506). As described earlier, examples of the hardware events are floating-point arithmetic operations, memory store (write) operations, memory load (read) operations, cache misses at a particular level of the cache memory subsystem, integer arithmetic operations, and so on.

A data model characterizes, during runtime of the application, the workloads of the one or more applications by analyzing the monitored hardware events and identifying computational patterns (or patterns) (block 508). As described earlier, the data model is one of a variety of types of deep learning models. A processor determines, for each identified pattern, whether the pattern is optimized or unoptimized (block 510). In an implementation, the data model stored an indication specifying whether the pattern is optimized or unoptimized. The processor determines, for each unoptimized pattern, whether an optimized version of the pattern is available (block 512). For example, a runtime library includes the optimized versions.

In an implementation, the processor stores, for each unoptimized pattern with an optimized version, identification and location of the unoptimized pattern and its optimized version (block 514). At a later time, during runtime of the application, for identified computational patterns whose corresponding program code is not currently running, the processor replaces the corresponding program code with new program code that has been optimized to perform operations being performed by the replaced code (block 516). In this manner, the data model, which uses deep learning techniques, performs automated detection of the computational patterns. The sampled and dynamic hardware events provide the input information for the data model. The automated detection leads to replacement of program code associated with unoptimized computational patterns with optimized versions while the application is running. Unlike software profilers, using hardware performance counters provide relatively easy access to information indicating the dynamic behavior of applications. In addition, in such implementation it isn't necessary to instrument the program code in order to gather the desired information. However, it is noted that in some implementation, program code can be instrumented to provide some additional information which is then used to identify computational patterns.

It is noted that one or more of the above-described embodiments include software. In such embodiments, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various embodiments, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
identify a first computational pattern during execution of a first version of program code of an application; and
replace the first version of program code with a second version of program code in the application, in response to determining the second version of program code includes program code optimized for performing one or more operations performed by the first version.

2. The processor as recited in claim 1, wherein the second version of program code is optimized based on criteria comprising one or more of performance, power consumption, and resource utilization.

3. The processor as recited in claim 1, wherein the circuitry is configured to identify the first computational pattern based at least in part on hardware performance counters.

4. The processor as recited in claim 1, wherein the second version of program code comprises one or more library routines.

5. The processor as recited in claim 1, wherein the circuitry is configured to recompile program code of the application during runtime to replace the first version of program code with the second version of program code.

6. The processor as recited in claim 1, wherein the circuitry is further configured to replace the first version of program code at a given point in time, in response to determining the first version of program code is not currently being executed.

7. The processor as recited in claim 6, wherein the circuitry is further configured to determine the given point in time has been reached, in response to determining a particular type of workload has been identified.

8. A method comprising:
identifying a first computational pattern during execution of a first version of program code of an application; and
replacing the first version of program code with a second version of program code in the application, in response to determining the second version of program code includes program code optimized for performing one or more operations performed by the first version.

9. The method as recited in claim 8, wherein the second version of program code is optimized based on criteria comprising one or more of performance, power consumption, and resource utilization.

10. The method as recited in claim 8, comprising identifying the first computational pattern based at least in part on hardware performance counters.

11. The method as recited in claim 8, wherein the second version of program code comprises one or more library routines.

12. The method as recited in claim 8, further comprising recompiling program code of the application during runtime to replace the first version of program code with the second version of program code.

13. The method as recited in claim 8, further comprising replacing the first version of program code at a given point in time, in response to determining the first version of program code is not currently being executed.

14. The method as recited in claim 13, further comprising determining the given point in time has been reached, in response to determining a particular type of workload has been identified.

15. A computing system comprising:
a memory configured to store instructions of an application and source data to be processed by the application;
an integrated circuit comprising circuitry configured to:
identify a first computational pattern during execution of a first version of program code of an application; and
replace the first version of program code with a second version of program code in the application, in response to determining the second version of program code includes program code optimized for performing one or more operations performed by the first version.

16. The computing system as recited in claim 15, wherein the second version of program code is optimized based on criteria comprising one or more of performance, power consumption, and resource utilization.

17. The computing system as recited in claim 15, wherein to identify the first computational pattern, the circuitry is configured to send, to a data model, data corresponding to one or more hardware performance counters.

18. The computing system as recited in claim 17, wherein the data model is trained to identify different versions of computational patterns by processing a variety of applications on hardware of the processor and inspecting the one or more hardware performance counters.

19. The computing system as recited in claim 15, wherein the second version of program code comprises one or more library routines.

20. The computing system as recited in claim 15, wherein the circuitry is further configured to replace the first version of program code at a given point in time, in response to determining the first version of program code is not currently being executed.
